(19) United States
(12) Patent Application Publication
(10) Pub. No.: US 2021/0397783 A1
(43) Pub. Date: Dec. 23, 2021

(54) RICH MEDIA ANNOTATION OF COLLABORATIVE DOCUMENTS

(71) Applicant: Mote Technologies, Inc., Danville, CA (US)

(72) Inventors: William M. Jackson, Denville, CA (US); Adam H. Nunes, London (GB)

(21) Appl. No.: 17/334,596

(22) Filed: May 28, 2021

Related U.S. Application Data
(60) Provisional application No. 63/041,760, filed on Jun. 19, 2020.

(51) Int. Cl. G06F 40/169

(52) U.S. Cl. CPC G06F 40/169; G06F 3/0484

(57) ABSTRACT

Methods and systems describe providing for media annotations for collaborative documents. The system receives a collaborative document based on a collaborative document platform; receives, from the client device, a user interaction of an annotation area within the collaborative document; provides one or more interactive recording components for the annotation area; receives a signal to initiate recording using at least one of the interactive recording components; generates, in response to receiving the signal to initiate recording, a media recording comprising one or more sample portions; generates a transcript based on the one or more sample portions of the generated media recording; and provides, for display on the client device, the generated media recording and the generated transcript.

### CROSS-REFERENCE TO RELATED APPLICATIONS

This application claims the benefit of U.S. Provisional Application No. 63/041,769, filed Jun. 19, 2020, which is hereby incorporated by reference in its entirety.

### FIELD OF THE INVENTION

The present invention relates generally to digital document collaboration tools, and more particularly, to systems and methods providing for the rich media annotation of collaborative documents.

### BACKGROUND

Digital document collaboration tools have been essential in providing the ability for people and organizations to share documents online and collaborate on them remotely, e.g., over the internet. Google Docs is one such popular example. While the ability to create and share documents for collaboration and editing has been welcome, there still remains some issues around providing annotations (i.e., comments) and feedback to collaborators within the same document. In many cases, comments are limited to strictly text-based interactions between collaborators, which may not convey a number of fuller subtextual nuances which may be only properly communicated by, e.g., audio or video. For example, off-the-cuff laughter or a varied tone of voice for a suggestion given in an audio recording may convey the subtextual nuance that the suggestion is not to be given a high amount of weight or seriousness, whereas a version limited to only text may give the impression that the suggestion is to be assigned some level of importance and weight.

A number of applications exist which include some functionality to create annotations or comments with media beyond just text, such as, e.g., the generation of audio recordings which can be shared at various annotation points throughout the collaborative document. The existing applications are suboptimal in a number of ways. First, they may often lead to a significant impact on browser performance. Second, they may be complicated and hard to use, or require multiple clicks or steps on the part of the user. The high cognitive load required to initiate a rich media recording and develop a habit of doing so with collaborators is often too high for users to stick with in the long-term. Third, there is often no clear indication or prompting to remind a user that the feature exists, leading new user adoption for medium-term or long-term usage to be limited. Finally, while the rich media annotation may be provided for, automatic or intelligent transcription has not been achieved yet for such tools.

Thus, there is a need in the field of digital collaborative tools to create a new and useful system and method for the rich media annotation of collaborative documents. The source of the problem, as discovered by the inventors, is a lack of such rich media annotation tools which are simple to use, require only a minimal performance impact, provide some measure of prompting to remind users that the new tool is an option or alternative to text annotation, and which provide transcription of the rich media annotation.

### SUMMARY

The invention overcomes the existing problems in a number of ways. First, by providing annotation which can be deeply integrated into document collaboration platforms, the cognitive load required for users to initiate recordings and develop engrained habits decreases significantly. Second, prompting may be provided for periodic reminders that media recording, such as voice feedback, can be an option or alternative to text feedback. Such prompting is often a key factor in successfully establishing new engrained behaviors in users. Third, there is minimal performance impact on the computer system. Through deep integration with document collaboration platforms, and through applying web-based technologies, the invention avoids the major browser performance impact which characterizes many of the previous attempts at online document annotation. Fourth, automated transcription generation and the optional editing of transcripts allows the recipient to choose between reading, listening, watching, or some combination thereof. This can suit different learning styles of users as well as different work environment contexts. Fifth, real-time processing and playback of audio after recording can allow for rapid playback and communication with collaborators and successful asynchronous collaboration on documents online.

One embodiment relates to a method for providing media annotations for collaborative documents. The method includes receiving a collaborative document based on a collaborative document platform; receiving, from the client device, a user interaction of an annotation area within the collaborative document; providing one or more interactive recording components for the annotation area; receiving a signal to initiate recording using at least one of the interactive recording components; generating, in response to receiving the signal to initiate recording, a media recording comprising one or more sample portions; generating a transcript based on the one or more sample portions of the generated media recording; and providing, for display on the client device, the generated media recording and the generated transcript.

In some embodiments, the method includes further receiving, from the client device, a signal to initiate playback of the recording, such as via the user clicking on a user interface component for playback of the recording; and initiating playback of the recording. In some embodiments, a transcript can begin processing while the recording is still underway and/or the audio file is still being processed for playback.

Further areas of applicability of the present disclosure will become apparent from the detailed description, the claims and the drawings. The detailed description and specific examples are intended for illustration only and are not intended to limit the scope of the disclosure.

### BRIEF DESCRIPTION OF THE DRAWINGS

The present disclosure will become better understood from the detailed description and the drawings, wherein:

FIG. 1A is a diagram illustrating an exemplary environment in which some embodiments may operate.

FIG. 1B is a diagram illustrating an exemplary computer system that may execute instructions to perform some of the methods herein.

FIG. 2A is a flow chart illustrating an exemplary method that may be performed in some embodiments.

FIG. 2B is a flow chart illustrating additional steps that may be performed in accordance with some embodiments.

FIG. 3A is a diagram illustrating one example embodiment 300 of providing media annotations within a collaborative document, in accordance with some embodiments.

FIG. 3B is a diagram illustrating one example embodiment 320 of generating a media recording within a collaborative document, in accordance with some embodiments.

FIG. 3C is a diagram illustrating one example embodiment 340 of generating a landing page for a media recording, in accordance with some embodiments.

FIG. 3D is a diagram illustrating one example embodiment 360 of a rendered annotation, in accordance with some embodiments.

FIG. 4A is a diagram illustrating one example embodiment 400 of a generalized annotation for a collaborative document, in accordance with some embodiments.

FIG. 4B is a diagram illustrating one example embodiment 450 of a comment with rich media within a collaborative document, in accordance with some embodiments.

FIG. 5 is a diagram illustrating one example embodiment 500 of a timeline for recording and processing, in accordance with some embodiments.

FIG. 6 is a diagram illustrating an exemplary computer that may perform processing in some embodiments.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

I. Exemplary Environments

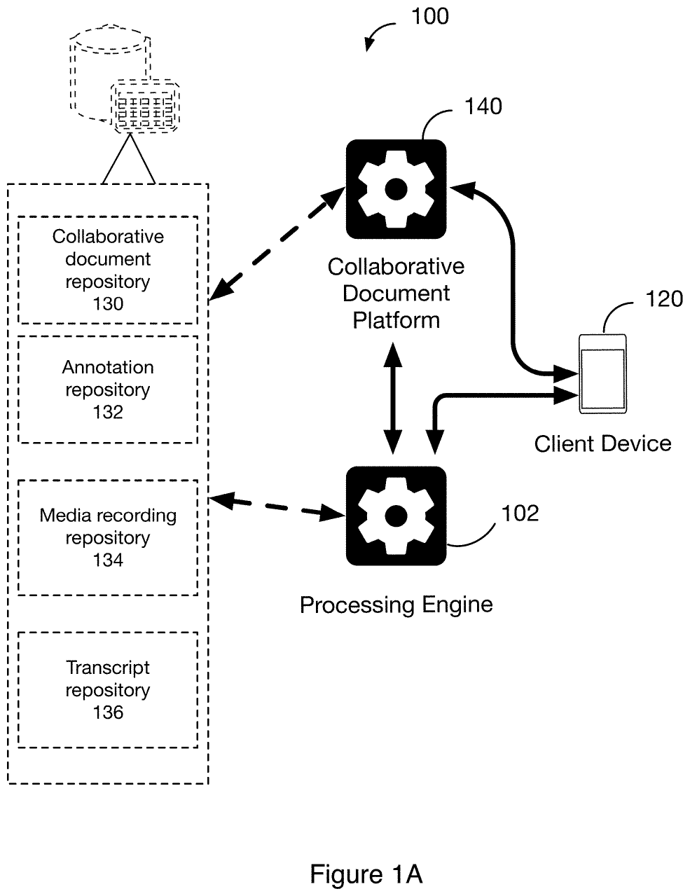

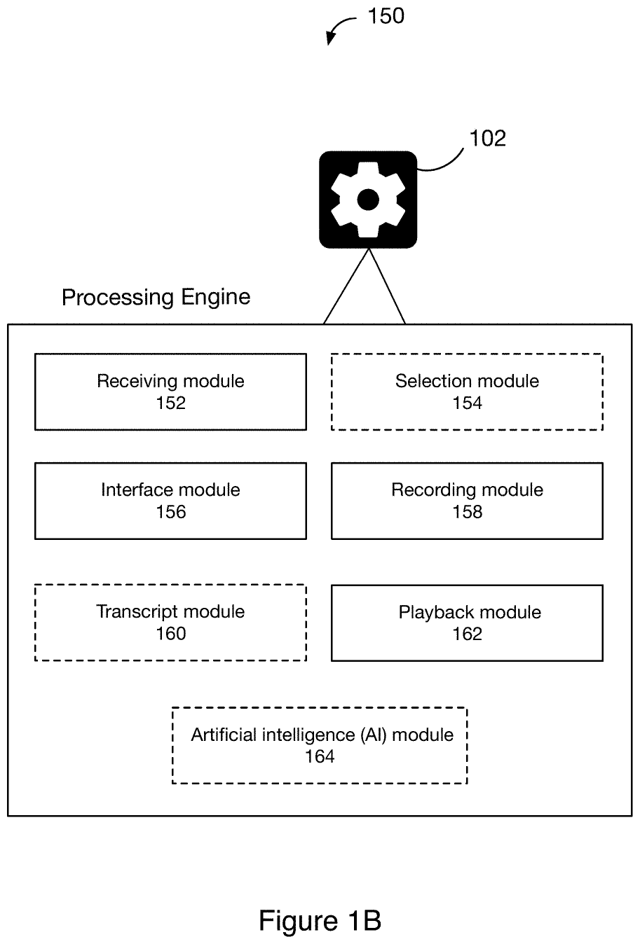

FIG. 1A is a diagram illustrating an exemplary environment in which some embodiments may operate. In the exemplary environment 100, a client device 120 is connected to a processing engine 102 and a collaborative document platform 140. The processing engine 102 is connected to the collaborative document platform 140, and optionally connected to one or more repositories and/or databases, including a collaborative document repository 130, annotation repository 132, media recording repository 134, and/or a transcript repository 136. One or more of the databases may be combined or split into multiple databases. The client device 120 in this environment may be a computer, and the collaborative document platform 140 and processing engine 102 may be applications or software hosted on a computer or multiple computers which are communicatively coupled via remote server or locally.

The exemplary environment 100 is illustrated with only one client device, one processing engine, and one collaborative document platform, though in practice there may be more or fewer client devices, processing engines, and/or collaborative document platforms. In some embodiments, the client device, processing engine, and/or collaborative document platform may be part of the same computer or device.

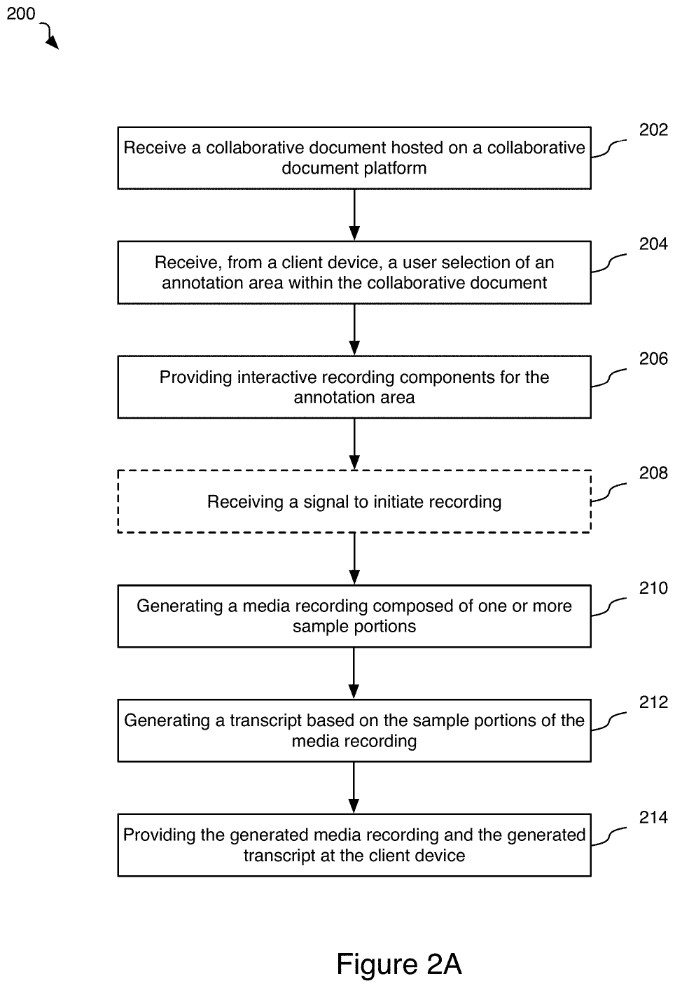

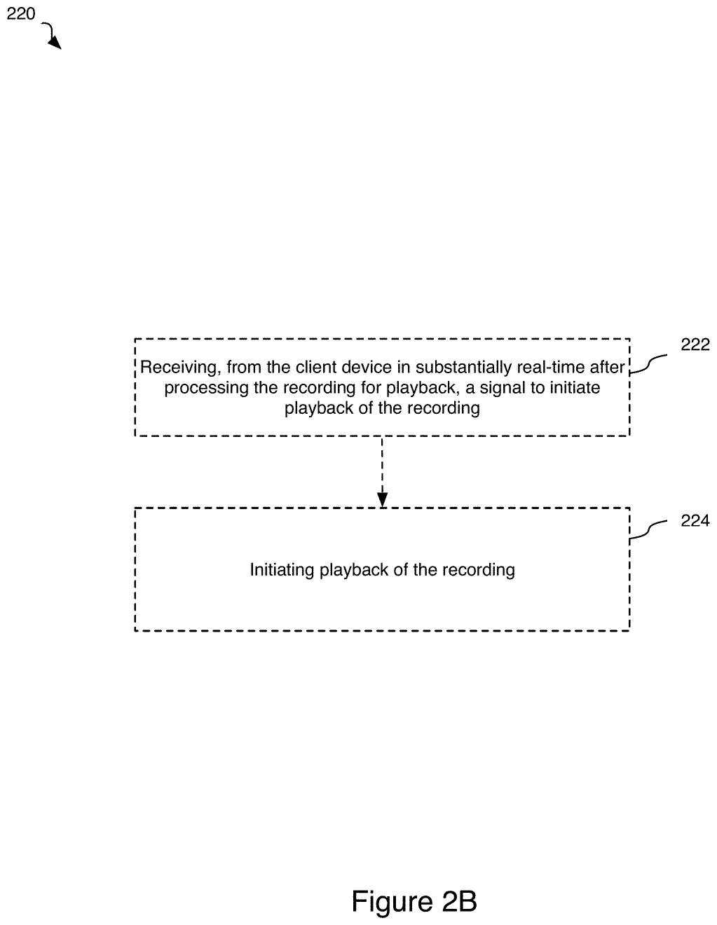

In an embodiment, the processing engine 102 may perform the method 200 (FIG. 2A) or other method herein and, as a result, provide media annotations for collaborative documents in an automated or semi-automated fashion. In some embodiments, this may be accomplished via communication with the client device, processing engine, collaborative document platform, and/or other device(s) over a network between the client device 120, processing engine, collaborative document platform, and/or other device(s) and an application server or some other network server. In some embodiments, the processing engine 102 is an application, browser extension, or other piece of software hosted on a computer or similar device, or is itself a computer or similar device configured to host an application, browser extension, or other piece of software to perform some of the methods and embodiments herein.

Client device 120 is a device with a display configured to present information to a user of the device. In some embodiments, the client device 120 presents information in the form of a user interface (UI) with UI elements or components. In some embodiments, the client device 120 sends and receives signals and/or information to the processing engine 102 and/or collaborative document platform 140. In some embodiments, client device 120 is a computing device capable of hosting and executing one or more applications or other programs capable of sending and/or receiving information. In some embodiments, the client device 120 may be a computer desktop or laptop, mobile phone, virtual assistant, virtual reality or augmented reality device, wearable, or any other suitable device capable of sending and receiving information. In some embodiments, the processing engine 102 and/or collaborative document platform 140 may be hosted in whole or in part as an application or web service executed on the client device 120. In some embodiments, one or more of the collaborative document platform 140, processing engine 102, and client device 120 may be the same device.

In some embodiments, optional repositories can include one or more of a collaborative document repository 130, annotation repository 132, media recording repository 134, and/or transcript repository 136. The optional repositories function to store and/or maintain, respectively, collaborative documents associated with the collaborative document platform 140, annotations generated via the processing engine 102, media recordings generated via the processing engine 102, and transcripts generated via the processing engine 102. The optional database(s) may also store and/or maintain any other suitable information for the processing engine 102 or collaborative document platform 140 to perform elements of the methods and systems herein. In some embodiments, the optional database(s) can be queried by one or more components of system 100 (e.g., by the processing engine 102), and specific stored data in the database(s) can be retrieved.

FIG. 1B is a diagram illustrating an exemplary computer system 150 with software modules that may execute some of the functionality described herein.

Receiving module 152 functions to receive information or documents from one or more sources, such as a collaborative document platform 140 or client device 120, and then functions send the information or documents to the processing engine 102. In some embodiments, this information can include metadata and/or files related to collaborative documents from a collaborative document platform 140, as described below with respect to FIG. 2.

Selection module 154 functions to present a user of the client device 120 with user interface elements which prompt the user to select an annotation area within the received collaborative document, then receive information about the selected annotation area from the client device 120, as described below with respect to FIG. 2.

Interface module 156 functions to provide, for display on the client device, a user interface with user elements for annotating the collaborative document within the selected annotation area, as described below with respect to FIG. 2.

Recording module 158 functions to generate one or more media recordings as media annotations to be placed within the annotation area, as described below with respect to FIG. 2.

Optional transcript module 160 functions to generate automatic transcripts from one or more generated media recordings, as described below with respect to FIG. 2.

Playback module 162 functions to provide, on a client device, playback of one or more media annotations and/or media recordings from within the annotation area.

Optional artificial intelligence (AI) module 164 functions to train one or more AI (e.g., machine learning or other suitable AI) models to perform one or more steps of the invention, as described below with respect to FIG. 2.

The above modules and their functions will be described in further detail in relation to an exemplary method below.

II. Exemplary Method

FIG. 2A is a flow chart illustrating an exemplary method that may be performed in some embodiments.

At step 202, the system receives a collaborative document hosted on a collaborative document platform. A collaborative document platform is a platform configured for generating, editing, and maintaining documents which can be optionally collaborated on by two or more users of the platform asynchronously. In some embodiments, the collaborative document platform can be a Software-as-a-Service (SaaS) application, website, web application, mobile or desktop application or client, browser extension, or any other system hosted via computer systems and capable of sending and/or receiving information via online networks. One example of a collaborative document platform is Google Docs, a popular word processor included as part of a web-based software office suite offered by Google, which allows users to create and edit files online while collaborating with other users in real-time. Within the office suite offered by Google, other web applications such as Google Slides, Google Sheets, and Google Classroom may also be considered collaborative document platforms to the extent they allow for two or more users to collaboratively edit documents (e.g., spreadsheets or presentations) in real time. In some embodiments, the collaborative document hosted on the collaborative document platform allows for edits to the document which are tracked by users with a revision history presenting changes. In some embodiments, the collaborative document platform has existing functionality for adding text-based annotations, e.g. notes or comments, to selected portions of the document.

In some embodiments, the system delivers one or more prompts to the user during the user's experience navigating and working on the collaborative document. The prompts may provide some form of notification, message, or gentle reminder that voice feedback, video feedback, or other forms of feedback are options and alternatives to text-based feedback. Such prompting can be as unobtrusive as a small logo or pictogram on the screen, some intermittent animation or movement, a push notification, or any other suitable prompts within the user experience.

At step 204, the system receives, from a client device, a user selection of an annotation area within the collaborative document. In some embodiments, the collaborative document is displayed on the client device, within a user interface for the collaborative document platform. In some embodiments, the system provides the user with the ability to select portions of the document (such as a word, sentence, or paragraph) to be annotated. In some embodiments, this ability to select portions is an existing part of the functionality of the collaborative document platform, while in other embodiments, the system specifically presents the functionality as added-on user interface elements, components, or input features as part of an integration between the collaborative document platform and other components of the system. For example, a user may be able to, either as existing functionality or added-on functionality, click and drag a mouse pointer across a selection of text, then right-click the mouse to bring up a pop-up menu with the option to generate a new annotation. In some embodiments, simply selecting a portion of text will bring up the pop-up menu with the option to generate a new annotation. Many other such configurations and possibilities can be contemplated. In some embodiments, the system receives the selection in the form of a specified location or identified portion of the document.

At step 206, the system provides, in response to receiving the user selection, one or more interactive recording components for the annotation area. In some embodiments, the interactive recording components are user experience (UX) or user interface (UI) components, such as, e.g., HTML-defined components, CSS-defined components, event listeners, or any other web-based components). In some embodiments, the recording components appear within a subset of the annotation area, such as, e.g., a smaller recording panel or recording section of the larger annotation area. In some embodiments, a pop-up window containing the annotation area appears directly or indirectly from the user selecting an annotation area within the collaborative document. In some embodiments, one or more interactive recording components can appear within the pop-up window. For example, a logo, graphic, pictogram, thumbnail image, or other image can appear within the annotation area. Upon clicking on the image, a signal to initiate a recording session on the client device can be generated and sent to a processing engine. In some embodiments, the recording component(s) are integrated into an annotation area within the collaborative document, while in others they may be free-floating, fixed to an area outside of the annotation area, or in some other region of the collaborative document as shown in the user interface. In some embodiments, the recording components can include one or more of a current user authentication status, control of various settings (e.g., content script suspension, transcription opt out selection, transcription language, recording quality, recording file format, recording input method, or any other suitable settings options), one or more integrations, one or more elements related to a storage service or database(s), or other suitable components. Many other recording components of various shapes, styles, or components may be contemplated.

In some embodiments, the recording components and other components of the system integrated or added on to the collaborative document platform are defined within a content script. In some embodiments, the content script is executed upon every page load and every subsequent mutation or modification of the web page's Document Object Model (DOM). In some embodiments, the content script injects one or more UX or UI components (e.g., HTML, CSS, event listeners, or other components) wherever a portion of the system exists or is integrated within the collaborative document platform.

In some embodiments, DOM query or manipulation code is used by the system to ensure that behavior is consistent across all elements and web applications and harmonious with the aesthetics and look and feel of the user interface. In some embodiments, expected CSS classes and/or text node content are matched across the elements. In some embodiments, the text value or elements and/or alternate focus is changed to ensure the host application smoothly incorporates insertions of URLs and other elements into the user experience.

In some embodiments, upon first usage of the components, e.g., for a new user, the content script requests the user to grant permission for the script to access the client device's built-in microphone if one exists, an external microphone or headset, or some other recording input device from the user (e.g., using a permissions API such as the HTML5 Permission API). New users may also be redirected to a website or other destination for signing in to a user account associated with the system (e.g., OAuth or another authentication service). Upon successful authentication, a user account is created within the processing engine, and the website sends one or more messages. In some embodiments wherein the system uses browser extension technology, the one or more messages are sent to the web browser's runtime API, and contain the contents of the newly created user account. An access token may also be sent in order to ensure authenticated and authorized communications between the browser extension and the processing engine or collaborative document platform.

Upon a user of the client device granting permission for the content script, the script triggers initiation of a recording being generated. In some embodiments, one or more user interface elements appear showing the time remaining for the recording in progress, a UI element to cancel the recording or finish the recording, or other suitable UI elements.

In some embodiments, the system includes a number of RESTful HTTPS resources for securely serving the extension and website, including, e.g., authentication, authorization, recording start/stop, acceptance of media samples, polling for workflow status, onward distribution of business analytics and technical telemetry events, or other suitable purposes within the system.

At optional step 208, the system receives, from the client device, a signal to initiate recording. As mentioned with respect to step 206, the system may receive a signal as part of a client's interactivity with a user interface, such as, e.g., clicking on a recording image or pictogram within the selected annotation area.

At step 210, in response to the signal to initiate recording, the system generates a media recording composed of one or more sample portions. Media recordings are any media which are intended to be placed in or embedded within a portion of the collaborative document as “rich media annotations”, i.e., media annotations or comments which are meant to be viewed, listened to, or otherwise played back and engaged with as an annotation to the selected text from step 204. In some embodiments, media recordings and media annotations can take the form of audio voice recordings or other audio recordings, video recordings, video or images captured from a video camera, screen recording, or other suitable media. In some embodiments, generating the media recording comprises generating the one or more sample portions which comprise the media recording. Upon generation of each sample portion, they may be sent to a repository or processed by one or more other modules of the processing engine.

In some embodiments, upon initiating recording, the content script triggers the sampling of audio from the recording input device at a predefined length of time (e.g., 250 milliseconds). In some embodiments, this is performed via media device and/or media recorder APIs. In some embodiments, each sample is encoded in a web format (such as, e.g., WebM). In some embodiments, after encoding, the sample may be stored within a media recording repository or database, or sent over HTTPS to one or more modules within the processing engine.

In some embodiments, once a sample is recorded, the system immediately begins processing the sample for playback. For example, 250 millisecond samples, i.e. “chunks”, of the recording can be received by the processing engine immediately once they are recorded, and concurrent to other samples being recorded. Thus, even while a user is still recording, multiple samples of the recording are being generated and sent to the processing engine, which processes the samples for eventual playback. In some embodiments, this pre-processing means that once the user has finished recording, most of the processing of the recording for playback has already been completed. Thus, the processing of the recording for playback can often be completed within a few seconds of the user or system terminating the recording session.

In some embodiments, the recording may terminate upon the occurrence of a termination event. A signal, message, or notification may be sent to the system regarding a termination event having occurred, and in response, the system can terminate the recording. For example, if recordings are limited to, e.g., 90 seconds of recording time, then upon 90 seconds elapsing, a message of a termination event is sent to the system to terminate the recording. Similarly, if the user clicks on a “cancel” or “finish” recording component, then a termination event is registered. In some embodiments, upon the initiation of the process of terminating a recording, the content script sends a “finalize request” message to instruct the processing engine to package the audio for distribution and/or playback. In some embodiments, the “finalize request” message may initiate a transcription of the recording, or take steps to finalize, store, and/or package a transcription. In some embodiments, the content script then polls the processing engine to render a finalized “card” or a final rendered version of the annotation area which will be viewable and playable by other users.

In some embodiments, media files (each containing, e.g., one or more sample portions or a full media recording) are uploaded initially to ephemeral storage (e.g., AWS or some other form of cloud storage). Upon the processing of the audio files, they can be sent to a permanent, public access storage or some other fixed storage. In some embodiments, the system uses EFS and/or similar suitable file architectures for media storage. Any other data needed by the extension which requires permanent, networked storage can be persisted in a cloud document database or other document database, including metadata, transcriptions, user account information or records, or any other suitable data.

In some embodiments, the system samples at a predefined time (for example, every 250 milliseconds) to capture the media (e.g., audio), and dispatches each sample portion to the back-end immediately or nearly immediately. In some embodiments, to minimize user-perceived workflow latency, if the media is longer than a certain minimal threshold time (such as 5 seconds), the media recording is flagged as a longer recording and a “preview” is created and sent to be processed for transcription by the processing engine immediately or as soon as the system can feasibly do so. Thus, on completion of a longer media recording, a preview of a subset of the recording may already appear within the user interface, while the remainder of the recording is in the process of completing transcription. In some embodiments, to minimize perceived latency, audio effects are additionally added for playback where the system is waiting for a response to a network request.

At step 212, the system generates a transcript based on the sample portions of the media recording. In some embodiments, upon a recording being initiated, the generation of a transcript for the recording may be concurrently or simultaneously initiated. For example, the system may initiate the recording and generate at least one sample portion, representing a subset of the full intended media recording. Upon moving on to generating another, different sample portion, one or more of the previous sample portions may be transcribed (e.g., text is generated from speech based on a voice audio recording). In some embodiments, this transcription is performed automatically by the system. In some embodiments, the transcription can be performed via one or more artificial intelligence (AI) models, such as a machine learning model, deep learning model, or other suitable AI model. In some embodiments, the AI models are trained on dataset(s) representing previous media recordings and/or transcripts. In some embodiments, the AI models are trained on the specific user's previous media recordings and/or transcripts. In some embodiments, the training datasets may also include edits which the user has made to the transcript.

In some embodiments, the system may provide the option for the user to edit the transcripts. This may be provided in order for the user to correct words or sections which have been inaccurately or wrongly transcribed. For example, a user may select a word within the transcript, and then is given the option within the user interface to replace the word with another word, or modify the text of the word as needed. In some embodiments, machine learning or other AI models may be applied to the transcript generation in order to preemptively correct names, specialized terminology, or other words or phrases which the user has previously made edits for or otherwise corrected within the system.

In some embodiments, the system automatically translates a transcript into a different language. For example, if the speaker and the intended recipient have different native languages, the automatic translation of a transcript into the intended recipient's native language can allow for high quality feedback, comments, and suggested corrections.

At step 214, the system provides the generated media recording and/or the generated transcript at the client device. In some embodiments, the media recording is playable directly within the annotation area. UX or UI elements, such as a play button, pause button, fast-forward button, rewind button, or stop button, may be provided for a user to control playback in various ways. In some embodiments, the transcript is viewable for the user and other users who are permitted to access and/or edit the document. In some embodiments the generated media recording and/or generated transcript are provided in real-time or substantially real-time upon termination of the recording. In some embodiments, the finalized elements may be rendered within the displayed user interface as a “card” or other visual presentation. The card can include, e.g., text annotations, the media recording with playback elements, a timestamp for when the annotations were generated, and/or other components.

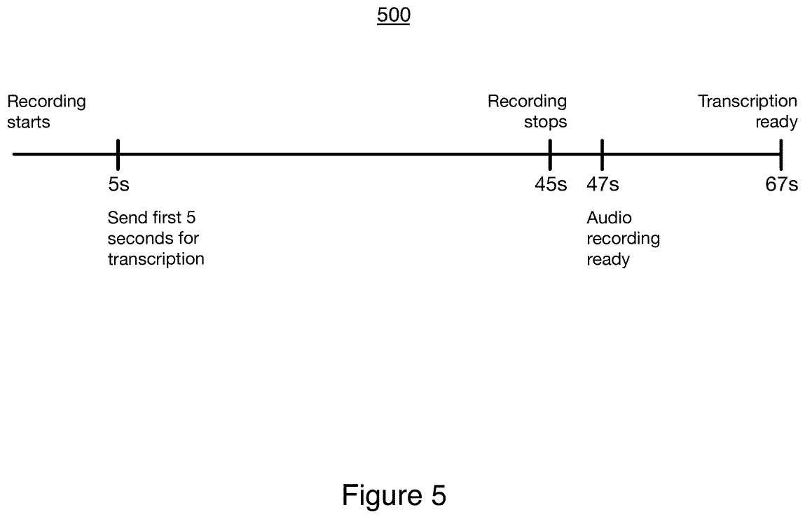

In some embodiments, a transcript can begin being processed from one or more sample portions of the recording while the recording is still underway and/or the audio file is being processed for playback. In some embodiments, some of the transcript can be initially viewable at or around the time the audio recording has been processed and is ready for playback. For example, the first 5 seconds of a transcript of the recording can be read at the time the full audio recording is available. The remaining portions of the transcript will still be processed while this occurs. An example of a timeline for processing and generation of a transcript will be discussed below with respect to FIG. 5.

In some embodiments, one or more components of the system can send analytics data or other information or metrics regarding the above steps to the processing engine, collaborative document platform, or other destinations as needed. In some embodiments, the analytics data can be sent into one or more analytics services, such as Google BigQuery, customer.io, or Amplitude. In some embodiments, error events are sent to error analysis services such as Datadog or Sentry.

FIG. 2B is a flow chart illustrating additional optional steps that may be performed in accordance with some embodiments.

At optional step 222, the system receives, from the client device in substantially real-time after processing the recording for playback, a signal to initiate playback of the recording. For example, in some embodiments, one or more samples, or smaller chunks, of the recording are generated and processed by the processing engine while the recording is still underway. In some embodiments, the system stitches together the individual samples of the recording in consecutive order or the order they were received in, such that playback would lead to seamless play of the samples in order, i.e., as one seamless recording. Once all samples are finished processing and/or the samples are stitched together, the system instantaneously or near-instantaneously displays a user interface component of a playback icon within the annotation area or other part of the user interface. Upon the user of the client device clicking on the user interface component of the playback icon, the client device sends a message to the processing engine indicating that the user wishes to play back the recording in question.

At optional step 224, the system initiates playback of the recording at the client device. The playback can occur via any form of media playback which can be contemplated within the client device. In some embodiments, streaming, caching, or other forms of playback of media can be incorporated.

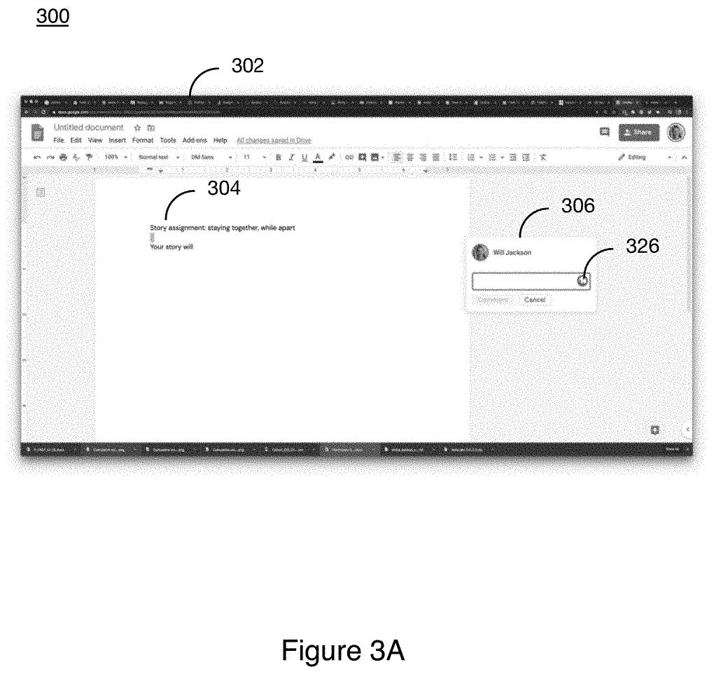

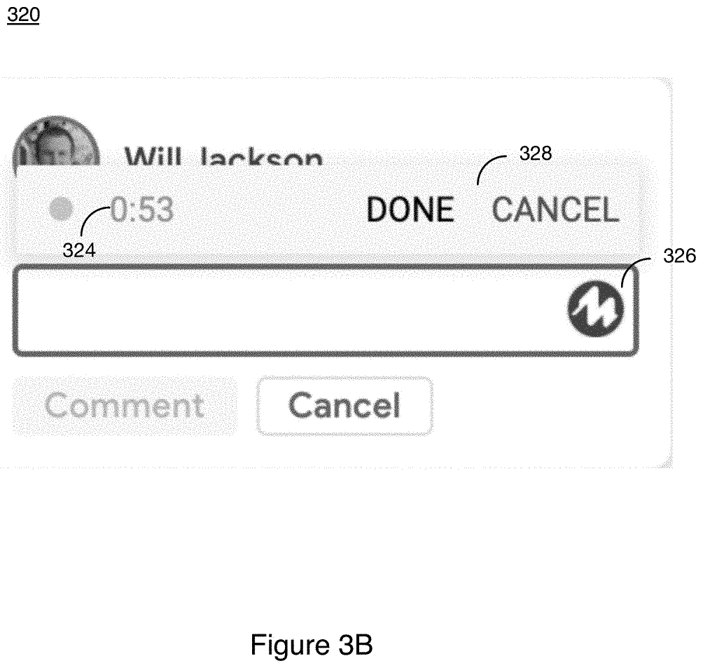

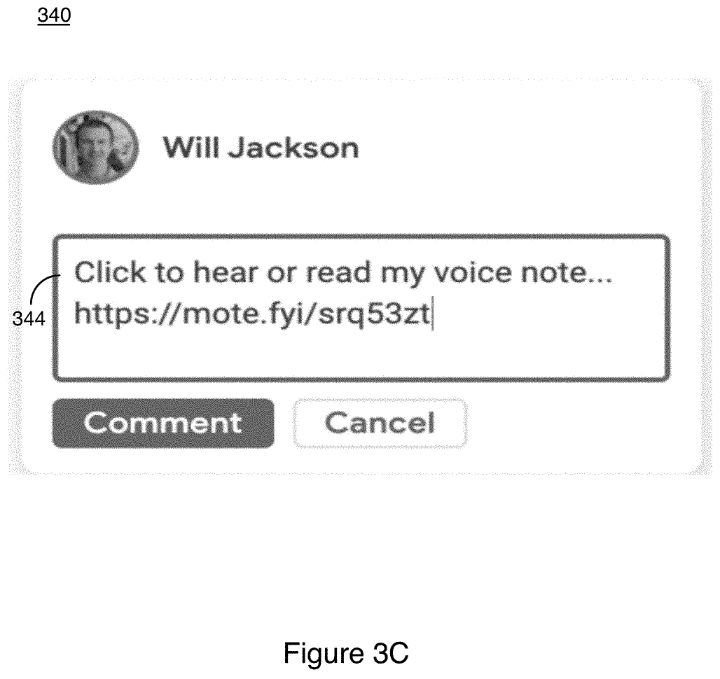

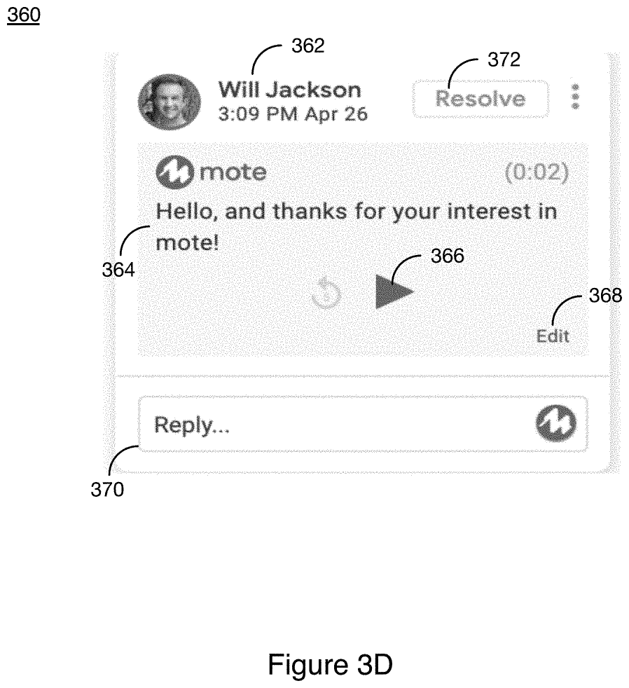

FIG. 3A is a diagram illustrating one example embodiment 300 of providing media annotation within a collaborative document, in accordance with some embodiments. FIGS. 3A, 3B, 3C, and 3D together illustrate an example workflow for how a user navigates a user interface to prepare annotations within the collaborative document.

Within a user interface 302 displaying a collaborative document hosted by a collaborative document platform, text from the document is displayed at 304. A selection of a space on a line in between the first line (“Story assignment”) and the third line (“Your story will”) is a selected annotation area which has been selected by a user of a client device. Upon selecting a portion of the text area, the user may select a further menu option from a pop-up menu indicating that the user wishes to create an annotation (e.g., “New comment . . . ”). Upon selection, an annotation area 306 is generated in or near the right margin adjacent to the selected annotation area. The annotation area contains some user interface components, including a text field for entering in a text-based annotation, a user name and user profile picture display, a cancel button, and a recording component 326 in the form of a small “M” logo to the right of the text field. Upon the user clicking the “M” logo, a recorded is initiated.

FIG. 3B is a diagram illustrating one example embodiment 320 of generating a media recording within a collaborative document, in accordance with some embodiments. After the user clicks on the recording component 326 as described above with respect to FIG. 3A, additional user element components are added to the annotation area. Specifically, a time elapsed component 324 displays the amount of time which has passed since recording was initiated, and also provides visual, changing indication that a recording is in progress. UI elements 328 are also provided for the user signaling that he or she is “done” with the recording, in which case the recording process is terminated and the media recording is finalized and packaged for playback, or that he or she wishes to “cancel” the recording, in which case the recording process is terminated and the media recording is discarded rather than finalized. In this example, the recording is limited to a ceiling of 60 seconds, so after 7 more seconds, the recording will immediately terminate and finalize without the user needing to click the “done” button.

FIG. 3C is a diagram illustrating one example embodiment 340 of generating a landing page for a media recording, in accordance with some embodiments. In this example and within some embodiments, upon the recording being terminated and finalized for playback, a URL 344 is automatically generated and displayed within the annotation area. Upon the user clicking on the URL or pasting the URL into a browser address field, a landing page is displayed wherein the media recording is presented for playback. In this way, even for users who may have some technical limitations or technical issues with playback of the media recording within the annotation area (for example, the user's browser does not have the requisite browser extension installed, or the user's browser is out of date or only semi-supported for the web applications involved), an automatically generated landing page can be visited via an automatically generated URL for immediate or nearly immediate playback of the media recording with a lower chance of issues being presented. Upon the user clicking on the “Comment” button, the annotation is finalized into a “card”, as shown below in FIG. 3D.

FIG. 3D is a diagram illustrating one example embodiment 360 of a rendered annotation, in accordance with some embodiments. Upon the user clicking a “Comment” button or similar UI component signaling the user's intent to finalize and complete the annotation generation process, the annotation area is rendered and finalized into a “card” such as the one shown below. This rendered card is how the annotation will appear for other users, such as other users collaborating with the user of the client device on the same collaborative document. The name of the user who generated the document 362 is displayed at the top. A transcript of the media recording was automatically generated and is displayed at 364. A time in parenthesis indicates how long the media recording is. A playback UI component 366 will play back the media recording upon a user clicking it. An “edit” button 368 gives a user the option to edit the transcript to correct errors. A “reply” text field is also presented, whereby a user can reply to the annotation with a comment of his or her own, either with a text-based comment or a media recording via the “M” recording component on the lower right of the window. Lastly, a “resolve” button 372 can be clicked, wherein the annotation is marked as resolved and, in some embodiments, is grayed out to indicate that the collaborators have read and resolved any issues associated with the comment.

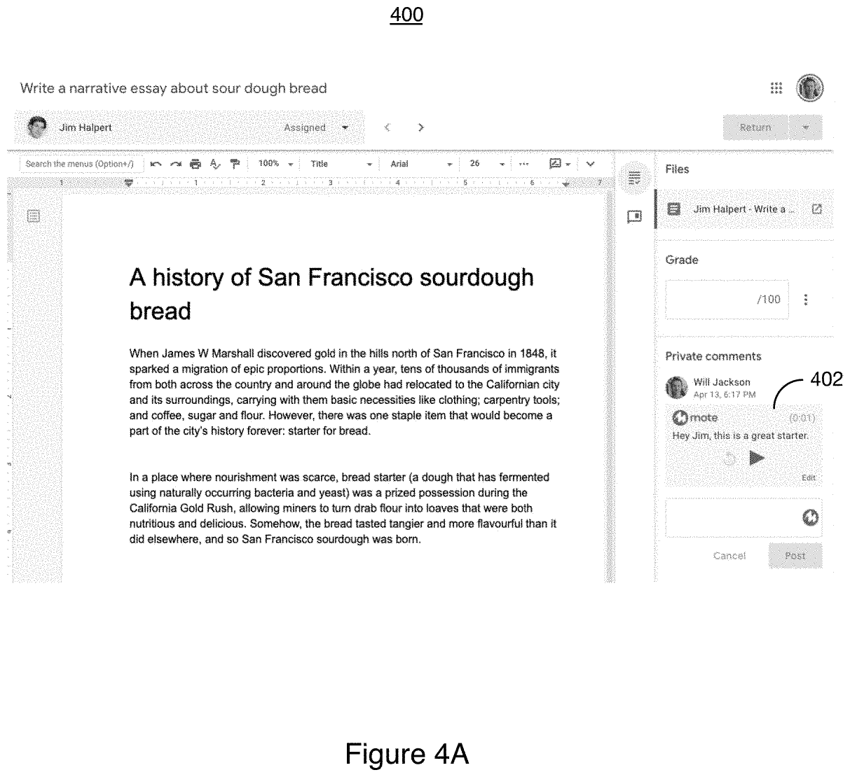

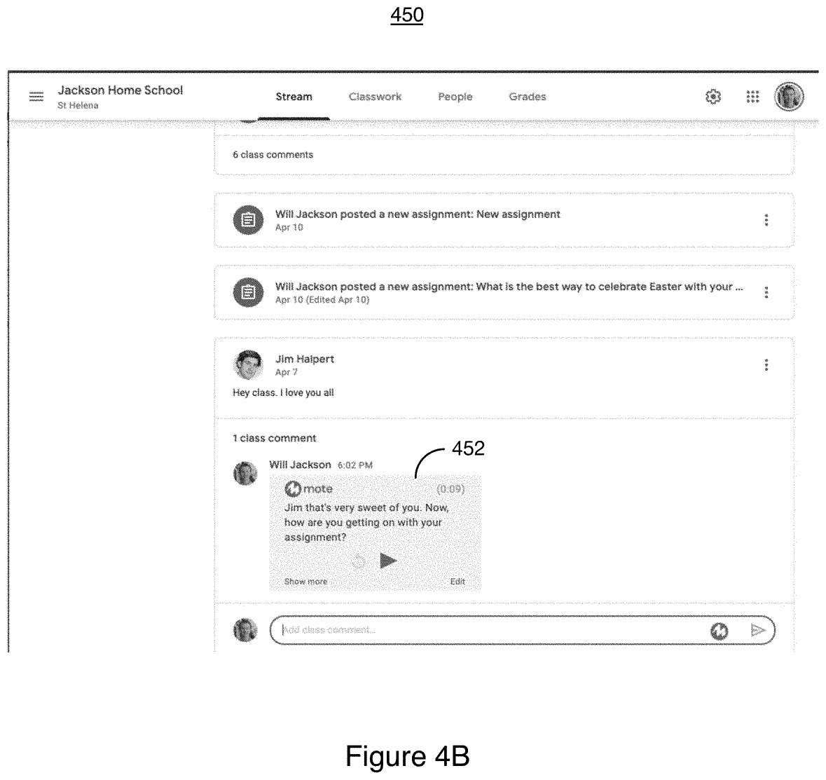

FIG. 4A is a diagram illustrating one example embodiment 400 of a generalized annotation for a collaborative document, in accordance with some embodiments. Collaborative documents may be used in many different contexts and embodiments, including in e-learning and/or online classroom contexts. Embodiment 400 illustrates an e-learning/online classroom example where the collaborative document is an assignment for the class to be completed by a student. In this example, Jim Halper is a student enrolled in the class, and the document is an assignment currently in progress by the student. On the right side of the screen, a private comment 402 is provided by the teacher of the online classroom. The private comment is a generalized annotation for the document, i.e., it is a comment about the assignment in general, rather than a comment about a specific section of the document. In this example, the comment is private, i.e., the comment is not viewable to the student's classmates, but viewable by the student and the teacher. In some embodiments, one or more collaborators can specify permissions or a subset of collaborators or users of a platform who have access to one or more specific annotations.

FIG. 4B is a diagram illustrating one example embodiment 450 of a comment with rich media within a collaborative document, in accordance with some embodiments. The context of example embodiment 450 is an e-learning environment or online classroom, as in FIG. 4A. In this example, a class comment 452 with rich media is provided. The class comment may be provided on, e.g., a “stream”, chat, channel, or other form of communication which is provided as a subset of the e-learning or online classroom offerings. The class comment, i.e., comment which is viewable by the entire class, can be considered a “public” or “semi-private” comment, in contrast to the “private comment” illustrated in FIG. 4A. As shown, the teacher may use voice notes or other rich media as a way to communicate with their entire class.

While FIGS. 4A and 4B show the context of an e-learning environment or online classroom, it will be appreciated by those knowledgeable in the art that private, public, or semi-public comments, generalized annotations, comments or annotations within, e.g., streams, can be used in many other contexts than e-learning environments or online classrooms. Such concepts can be applied to a wide variety of contexts and uses.

FIG. 5 is a diagram illustrating one example embodiment 500 of a timeline for recording and processing, in accordance with some embodiments. The timeline shows a chronological sequence, including the start and ending of a recording session as well as the processing and preparation of various components, including audio and a transcript. The timeline is described from left to right as the sequence proceeds. It will be understood that the times shown are just examples and multiple possible times can exist in various embodiments.

At 0 seconds, the recording starts. This may be caused by, e.g., pressing a recording button within the annotated area, such as the start recording button 326 shown in FIG. 3A. At 5 seconds into the recording session, the system sends the first 5 seconds to a processing engine (such as a cloud processing engine) to begin processing of a transcript. The audio of the first 5 seconds is one sample portion (i.e. “chunk”) of the recording. The recording continues, with additional sample portions being sent to the processing engine for processing of a transcript. Concurrently, sample portions may be sent to the processing engine for processing and preparation of audio.

At 45 seconds in, the recording stops. This termination may be caused by the user pressing a “stop” button within the UI, for example, such as the stop recording component 326 in FIG. 3B.

At 47 seconds in, the audio recording is ready. The sample portions of the recording had been processing for playback during the recording process, such that 2 seconds after recording stops, the processing can be completed. At this point, the user may see a link, such as the link 344 shown in FIG. 3C. At this point, the user can click to populate the card, and audio can be heard in its entirety. In addition, the first 5 seconds of the transcript can be read. This is because the transcription processing had started at 5 seconds into the recording.

At 67 seconds in, the transcription process is completed and the transcript is available for full viewing. Additionally, the user can edit the transcript as needed.

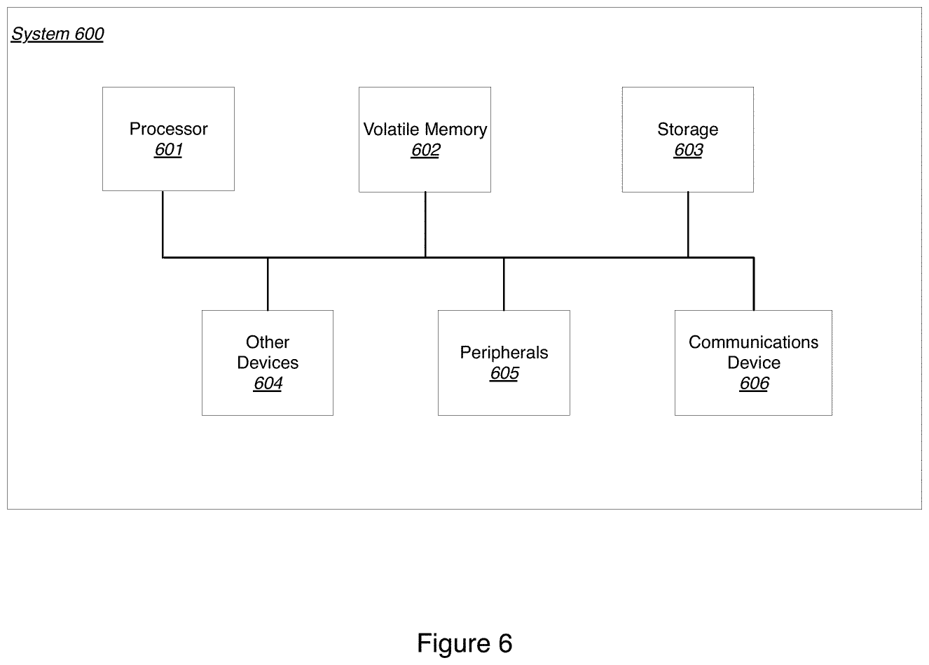

FIG. 6 is a diagram illustrating an exemplary computer that may perform processing in some embodiments. Exemplary computer 600 may perform operations consistent with some embodiments. The architecture of computer 600 is exemplary. Computers can be implemented in a variety of other ways. A wide variety of computers can be used in accordance with the embodiments herein.

Processor 601 may perform computing functions such as running computer programs. The volatile memory 602 may provide temporary storage of data for the processor 601. RAM is one kind of volatile memory. Volatile memory typically requires power to maintain its stored information. Storage 603 provides computer storage for data, instructions, and/or arbitrary information. Non-volatile memory, which can preserve data even when not powered and including disks and flash memory, is an example of storage. Storage 603 may be organized as a file system, database, or in other ways. Data, instructions, and information may be loaded from storage 603 into volatile memory 602 for processing by the processor 601.

The computer 600 may include peripherals 605. Peripherals 605 may include input peripherals such as a keyboard, mouse, trackball, video camera, microphone, and other input devices. Peripherals 605 may also include output devices such as a display. Peripherals 605 may include removable media devices such as CD-R and DVD-R recorders/players. Communications device 606 may connect the computer 100 to an external medium. For example, communications device 606 may take the form of a network adapter that provides communications to a network. A computer 600 may also include a variety of other devices 604. The various components of the computer 600 may be connected by a connection medium such as a bus, crossbar, or network.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A method for providing media annotations for collaborative documents, the method comprising:
receiving a collaborative document hosted on a collaborative document platform, wherein the collaborative document platform is connected to an online collaborative document repository;
providing, for display on a client device, a user interface comprising at least the collaborative document;
receiving, from the client device, a user selection of an annotation area within the collaborative document;
providing, in response to receiving the user selection, one or more interactive recording components in the annotation area;
receiving, from the client device, a signal to initiate recording using at least one of the interactive recording components;
generating, in response to receiving the signal to initiate recording, a media recording comprising one or more sample portions;
generating a transcript based on the one or more sample portions of the generated media recording; and
providing, for display on the client device, the generated media recording and the generated transcript.

2. The method of claim 1, wherein generating the transcript comprises:
processing the one or more sample portions of the media recording for automatic transcription in real-time or substantially real-time concurrent to the generation of the sample portions of the media recording.

3. The method of claim 1, wherein providing the generated transcript comprises providing, within the annotation area, one or more interactive editing components for editing the text of the transcript.

4. The method of claim 1, wherein generating the transcript is performed by one or more artificial intelligence (AI) models.

5. The method of claim 4, wherein the one or more AI models are trained on one or more datasets comprising at least prior edits to the transcript from the user.

6. The method of claim 1, further comprising:
processing the recording for playback, wherein a portion of the transcript is viewable upon the recording being available for playback.

7. The method of claim 1, further comprising:
receiving, from the client device, a signal to initiate playback of the recording; and
initiating playback of the recording.

8. The method of claim 1, wherein generating the media recording comprises:
generating a sample portion of the media recording at every consecutive completion of a predefined period of time; and
sending each generated sample portion of the media recording to a processing engine immediately after generating the sample portion.

9. The method of claim 1, further comprising:
sending analytics data to one or more servers for further processing, wherein the analytics data comprises at least one of: user interaction data, media recording data, transcript data, operational metrics, and error events.

10. The method of claim 1, wherein one or more integrations with the collaborative document platform are executed using one or more of: runtime application programming interfaces (APIs), web libraries, and browser extension scripts.

11. The method of claim 1, wherein the annotation area represents the full content of the collaborative document, and wherein the media annotation is a generalized annotation referring to the collaborative document as a whole.

12. The method of claim 1, wherein the user interface is a communication channel within the collaborative document platform, and wherein the media annotation represents a comment within the communication channel.

13. A non-transitory computer-readable medium containing instructions for providing media annotations for collaborative documents, comprising:
instructions for receiving a collaborative document hosted on a collaborative document platform, wherein the collaborative document platform is connected to an online collaborative document repository;
instructions for providing, for display on a client device, a user interface comprising at least the collaborative document;
instructions for receiving, from the client device, a user selection of an annotation area within the collaborative document;
instructions for providing, in response to receiving the user selection, one or more interactive recording components in the annotation area;
instructions for receiving, from the client device, a signal to initiate recording using at least one of the interactive recording components;
instructions for generating, in response to receiving the signal to initiate recording, a media recording comprising one or more sample portions;
instructions for generating a transcript based on the one or more sample portions of the generated media recording; and
instructions for providing, for display on the client device, the generated media recording and the generated transcript.

14. The system of claim 13, wherein generating the transcript comprises:
instructions for processing the one or more sample portions of the media recording for automatic transcription in real-time or substantially real-time concurrent to the generation of the sample portions of the media recording.

15. The system of claim 13, wherein providing the generated transcript comprises instructions for providing, within the annotation area, one or more interactive editing components for editing the text of the transcript.

16. The system of claim 13, wherein generating the transcript is performed by one or more artificial intelligence (AI) models.

17. The system of claim 16, wherein the one or more AI models are trained on one or more datasets comprising at least prior edits to the transcript from the user.

18. The system of claim 13, further comprising:
instructions for processing the recording for playback, wherein a portion of the transcript is viewable upon the recording being available for playback.

19. The system of claim 13, further comprising:
instructions for receiving, from the client device, a signal to initiate playback of the recording; and
instructions for initiating playback of the recording.

20. The system of claim 13, wherein generating the media recording comprises:
instructions for generating a sample portion of the media recording at every consecutive completion of a predefined period of time; and
instructions for sending each generated sample portion of the media recording to a processing engine immediately after generating the sample portion.
